(19) United States
(12) Patent Application Publication
(10) Pub. No.: US 2017/0193937 A1
(43) Pub. Date: Jul. 6, 2017

(54) LIQUID CRYSTAL DISPLAY DEVICE AND GOA CIRCUIT

(71) Applicant: SHENZHEN CHINA STAR OPTOELECTRONICS TECHNOLOGY CO., LTD., Shenzhen (CN)

(72) Inventor: Peng DU, Shenzhen (CN)

(73) Assignee: Shenzhen China Star Optoelectronics Technology Co., Ltd., Shenzhen (CN)

(21) Appl. No.: 14/906,561

(22) PCT Filed: Dec. 30, 2015
(86) PCT No.: PCT/CN2015/099675

§ 371 Date: Jan. 21, 2016

(51) Int. Cl. G09G 3/36

(52) U.S. Cl. CPC G09G 3/3648; G09G 2300/08; G09G 2310/08

(57) ABSTRACT

A GOA (Gate driver On Array) for an LCD (Liquid Crystal Display) device is disclosed herein. The LCD device includes a plurality of scanning lines. The GOA circuit includes a plurality of cascaded GOA units. An (n)th level GOA unit correspondingly charges a scanning line. The (n)th level GOA unit includes a pull-down sustain circuit, a pull-up circuit, a bootstrap capacitor circuit, a pull-down circuit, and a clock circuit. The pull-down sustain circuit includes a first TFT (thin film transistor), a second TFT, a third TFT, and a fourth TFT to raise the stability of a gate signal point and to reduce the usage of the TFTs.

### BACKGROUND OF THE INVENTION

Field of Invention

The present invention relates to the field of liquid crystal display (LCD) devices, and more particularly to a GOA (Gate driver On Array) circuit.

Description of Prior Art

With the growing popularity of the narrow bezel design, panel design of the peripheral space is gradually compressed. In a conventional GOA circuit design, a wiring height of each level GOA circuit is the same as the corresponding pixel size; products with 4k or higher PPI (Pixel Per Inch) are widespread, and the wiring height for the GOA circuit is decreased accordingly. With the wiring height being limited, the wiring is only compensated by larger width, which is disadvantageous to the narrow bezel design.

A gate signal point Q(n) is a very important voltage in the GOA circuit, while the gate signal point Q(n) is high, the GOA circuit is at an on and output status; while the gate signal point Q(n) is low, the GOA circuit is at an off status, and an output corresponds to the low potential as the gate signal point Q(n).

Please refer to FIG. 1, which is a structural illustrative drawing of a GOA circuit 10 of the prior art. The GOA circuit 10 comprises a plurality of GOA units 15, which are cascaded with each other. The (n)th level GOA correspondingly charges for a scanning line.

The (n)th GOA unit comprises a clock circuit 100, a pull-down circuit 200, a bootstrap capacitor circuit 300, a pull-up circuit 400, and a pull-down sustain circuit 500. The basic circuit structure is constituted by the clock circuit 100, the pull-down circuit 200, the bootstrap capacitor circuit 300, and the pull-up circuit 400. The basic circuit structure comprises 4 TFTs (thin film transistors) and 1 capacitor. However, for due to reliability issues of the amorphous silicon, in addition to the basic circuit structure, the pull-down sustain circuit 500 is needed. The pull-down sustain circuit 500 has function of pull-down support, making sure that an output of the GOA circuit and a gate signal point Q(n) are at low potential while the gate line is off, to increase the reliability while the GOA circuit is working.

In the conventional design, 2 pull-down support circuits are designed, they are used to pull down the gate signal point Q(n) while the GOA circuit is off, to make the gate signal point Q(n) stays at low potential, to ensure the panels normal working and to raise the reliability. Generally, the pull-down support circuit is constituted of more TFTs; the TFTs also occupy a larger space, which is disadvantageous to the narrow bezel design. The two pull-down support circuits are described by FIG. 2.

Please refer to FIGS. 2 and 3. FIG. 2 is a structural illustrative drawing of another GOA circuit 20 of the prior art. FIG. 3 is an oscillogram (waveform) diagram of the GOA circuit of FIG. 2. The difference between the FIG. 2 and the FIG. 1 is: the pull-down sustain circuit 500 comprises a first pull-down support circuit 510 and a second pull-down support circuit 520. The first pull-down support circuit 510 and the second pull-down support circuit 520 are controlled respectively by two low frequency signals LC1 and LC2, to make the first pull-down support circuit 510 and the second pull-down support circuit 520 work in different periods in turn, to ensure the output of the GOA circuit and the gate signal point Q(n) are at low potential while the gate line is off. Potentials of the low frequency signal LC1 and the low frequency signal LC2 are opposite to each other. When the low frequency signal LC1 is at high potential, the low frequency signal LC2 is at low potential and the pull-down work is done by the first pull-down support circuit 510. After several frames, the first low frequency signal LC1 switches to be at low potential, the second low frequency signal LC2 switches to be at high potential, the pull-down work is done by the second pull-down support circuit 520. The pull-down sustain circuit 500 is able to have a different configuration. FIG. 3 uses 6 levels of CK signals to work with the two low frequency signals LC1 and LC2 which are exchanged after around 100 frames, to generate corresponding gate signals G(n). In FIG. 2, there is one important feature that each level GOA circuit only corresponds with an output of one gate line G(n). While the panel is applied with high PPI design, the amount of the gate lines will increase enormously; correspondingly, the maximum height occupied by the each level GOA circuit will decrease accordingly, so it is necessary to increase the width of the wiring region during design; thus the panel border region will be widen; in other words, the width of the border region needs to be increase to seek for more wiring space; this is disadvantageous to the narrow bezel design of the trend.

So there is a need to provide an LCD device and a GOA circuit to solve the technical problem.

### SUMMARY OF THE INVENTION

An objective of the present invention is to provide a GOA circuit for an LCD device.

To achieve the above purpose, the present invention provides a GOA circuit for an LCD device. The LCD device comprises a plurality of scanning lines. The GOA circuit comprises a plurality of GOA units, which are cascaded to each other as a plurality level of GOA units. An (n)th level GOA unit charges to a scanning line correspondingly. The (n)th level GOA unit comprises a pull-down sustain circuit, a pull-up circuit, a bootstrap capacitor circuit, a pull-down circuit, and a clock circuit.

The pull-down sustain circuit is used to connect with a gate signal point. The pull-up circuit is used to connect with the pull-down sustain circuit through the gate signal point. The bootstrap capacitor circuit is used to connect with the pull-up circuit through the gate signal point. The pull-down circuit is used to connect with the bootstrap capacitor circuit through the gate signal point. The clock circuit is used to connect with the pull-down circuit through the gate signal point and the scanning line, and is used to receive a clock signal.

The pull-down sustain circuit, the bootstrap capacitor circuit, and the pull-down circuit all connect to a direct-low-voltage source.

The pull-down sustain circuit comprises a first TFT (thin film transistor), a second TFT, a third TFT, and a fourth TFT.

The first TFT has a first control terminal which is connected with an input signal point, and has a second output terminal connected with the direct-low-voltage source. The second TFT has a second control terminal which is connected with a first input terminal of the first TFT, a second input terminal connected with the direct-low-voltage source, and a second output terminal connected with an output signal point. The third TFT, which comprises a third control terminal, a third output terminal, and a third input terminal, the third control terminal and the third output terminal connected with a direct-high-voltage source, and the third input terminal connected with the first input terminal. The fourth TFT having a fourth control terminal which is connected with the gate signal point, a fourth output connected with the third control terminal, and a fourth input terminal connected with the output signal point, the output signal point connected with the gate signal point.

In one preferred embodiment, the clock circuit comprises a fifth TFT and a sixth TFT. The fifth TFT has a fifth control terminal connected with the gate signal point, a fifth input terminal receives the clock signal, and a fifth output terminal connected with the scanning line. The sixth TFT has a sixth control terminal which is connected with the gate signal point, a sixth input terminal receives the clock signal, and a sixth output terminal outputs an (n)th level starting signal.

In one preferred embodiment, the bootstrap capacitor circuit comprises a first capacitor and a seventh TFT. The first capacitor has two terminals which are connected with the gate signal point and the scanning line. The seventh TFT has a seventh control terminal which receives a reset signal, a seventh input terminal connected with the direct-low-voltage source, and a seventh output terminal receives the scanning line.

In one preferred embodiment, the pull-up circuit comprises an eighth TFT. The eighth TFT has an eighth control terminal which receives an (n−3)th level starting signal, an eighth input terminal connected with the eighth control terminal, and an eighth output terminal connected with the gate signal point.

In one preferred embodiment, the pull-down circuit comprises a ninth TFT and a tenth TFT. The ninth TFT has a ninth control terminal which receives an (n+3)th level starting signal, a ninth input terminal connected with the direct-low-voltage source, and a ninth output terminal connected with the gate signal point. The tenth TFT has a tenth control terminal which is connected with the ninth control terminal, a tenth input terminal connected with the direct-low-voltage source, and a tenth output terminal connected with the scanning line.

In one preferred embodiment, the pull-down circuit comprises a ninth TFT, a tenth TFT, an eleventh TFT, and a twelfth TFT. The ninth TFT has a ninth input terminal connected with the direct-low-voltage source, and a ninth output terminal connected with the gate signal point. The tenth TFT has a tenth control terminal which is connected with a ninth control terminal, a tenth input terminal connected with the direct-low-voltage source, and a tenth output terminal connected with the scanning line. The eleventh TFT has an eleventh control terminal which receives a forward scanning signal, an eleventh input terminal receives an (n+3)th level starting signal, and an eleventh output terminal connected with the tenth control terminal. The twelfth TFT has a twelfth control terminal which receives a rearward scanning signal, a twelfth input terminal receives an (n−3)th level starting signal, and a twelfth output terminal connected with the eleventh output terminal.

In one preferred embodiment, the pull-up circuit comprises a thirteenth TFT and a fourteen TFT. The thirteenth TFT has a thirteenth control terminal which receives a forward scanning signal, a thirteenth input terminal receives an (n−3)th level starting signal, and a thirteen output terminal connected with the gate signal point. The fourteen TFT has a fourteenth control terminal which receives a rearward scanning signal, a fourteenth input terminal receives an (n+3)th level starting signal, and a fourteen output terminal connected with the thirteenth output terminal.

In one preferred embodiment, the output signal point connects with the input signal point.

In one preferred embodiment, an LCD device comprises the GOA circuit as above.

The present invention optimizes the GOA circuit design by connecting a potential-maintaining circuit with the gate signal point Q(n) in order to replace the pull-down circuit of the prior art. While the gate signal point Q(n) is at high potential or low potential, the gate signal point Q(n) is able to maintain high or low potential by the potential-maintaining circuit. It is advantageous to the narrow bezel design of the trend, by reducing the space occupied by the GOA circuit, without affecting the working reliability of the GOA circuit.

### BRIEF DESCRIPTION OF THE DRAWINGS

FIG. 1 is a structural illustrative drawing of a GOA circuit of the prior art;

FIG. 2 is a structural illustrative drawing of another GOA circuit of the prior art;

FIG. 3 is the oscillogram diagram of the GOA circuit of FIG. 2;

FIG. 4 is a structural illustrative drawing of a GOA circuit of a first preferred embodiment of the present invention;

FIG. 5 is an oscillogram diagram of the GOA circuit of FIG. 4;

FIG. 6 is a structural illustrative drawing of a GOA circuit of a second preferred embodiment of the present invention;

FIG. 7 is a forward-scanning oscillogram diagram of the GOA circuit of FIG. 6;

FIG. 8 is a rearward-scanning oscillogram diagram of the GOA circuit of FIG. 6; and

FIG. 9 is a drawing of an LCD device of the present invention.

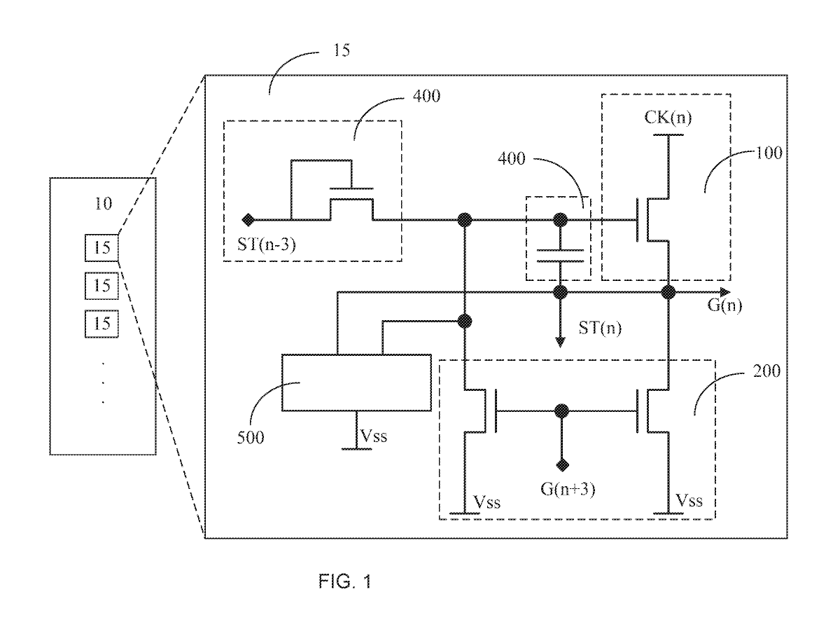

### DETAILED DESCRIPTION OF THE PREFERRED EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention. In the drawings, units with similar structures are marked with the same labels.

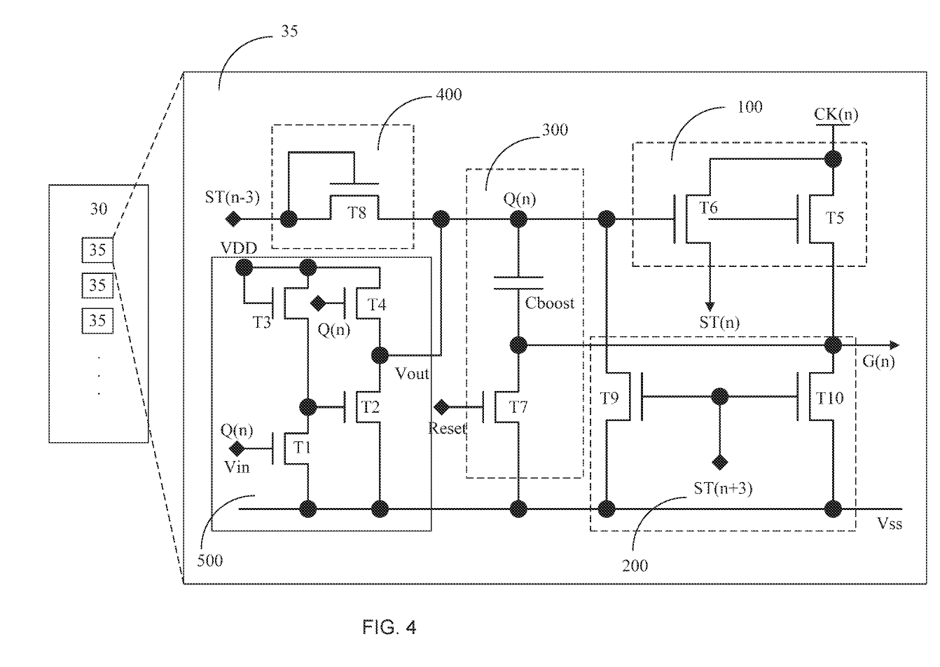

FIG. 4 is a structural illustrative drawing of a GOA circuit of a first preferred embodiment of the present invention. The GOA circuit 30 comprises a plurality of GOA units 35, which are cascaded with each other as a plurality of levels of GOA units 35. An (n)th level GOA unit 35 charges a scanning line G(n) correspondingly. The (n)th level GOA unit 35 comprises a pull-down sustain circuit 500, a pull-up circuit 400, a bootstrap capacitor circuit 300, a pull-down circuit 200, and a clock circuit 100.

The pull-down sustain circuit 500 is used to connect with a gate signal point Q(n). The pull-up circuit 400 is used to connect with the pull-down sustain circuit 500 through the gate signal point Q(n). The bootstrap capacitor circuit 300 is used to connect with the pull-up circuit 400 through the gate signal point Q(n). The pull-down circuit 200 is used to connect with the bootstrap capacitor circuit 300 through the gate signal point Q(n). The clock circuit 100 is used to connect with the pull-down circuit 200 through the gate signal point Q(n) and the scanning line G(n), and is used to receive a clock signal CK.

The pull-down sustain circuit 500, the pull-up circuit 400, the bootstrap capacitor circuit 300, the pull-down circuit 200, and the clock circuit 100 all connect to the gate signal point Q(n).

The pull-down sustain circuit 500, the bootstrap capacitor circuit 300, and the pull-down circuit 200 all connect to a direct-low-voltage source VSS.

The pull-down sustain circuit 500 comprises a first TFT (thin film transistor) T1, a second TFT T2, a third TFT T3, and a fourth TFT T4.

The first TFT T1 has a first control terminal which is connected with an input signal point Vin, and has a first input terminal is connected with the direct-low-voltage source VSS. The second TFT T2 has a second control terminal which is connected with a first input terminal of the first TFT T1, a second input terminal connected with the direct-low-voltage source VSS, and a second output terminal is connected with an output signal point Vout. The third TFT T3, comprises a third control terminal, a third output terminal, and a third input terminal; the third control terminal and the third output terminal are connected with a direct-high-voltage source VDD, and the third input terminal is connected with the first input terminal. The fourth TFT T4 has a fourth control terminal which is connected with the gate signal point Q(n), a fourth output terminal connected with the third control terminal, and a fourth input terminal connected with the output signal point Vout; the output signal point Vout is connected with the gate signal point Q(n).

The input signal point Vin and the output signal point Vout are respectively represented as the input terminal and the output terminal of the GOA unit. It is shown from the drawings that the input signal point Vin and the output signal point Vout of the GOA unit 35 are both the gate signal point Q(n). Besides, the direct-high-voltage source VDD is a direct signal with high potential. The feature of this circuit is that the input signal point Vin and the output signal point Vout are signals with the same potentials, while the input signal point Vin is at low (high) potential, the output signal point Vout will be at low (high) potential, too, in order to achieve a function of maintaining the potential stability. In the design of FIG. 4, the input signal point Vin and the output signal point Vout of the GOA unit 35 are both connected with the gate signal point Q(n); the purpose is to maintain the potential stability of the gate signal point Q(n).

The clock circuit 100 comprises a fifth TFT T5 and a sixth TFT T6. The fifth TFT T5, has a fifth control terminal connected with the gate signal point Q(n), a fifth input terminal receiving the clock signal CK, and a fifth output terminal connected with the scanning line G(n). The sixth TFT T6 has a sixth control terminal which is connected with the gate signal point Q(n), a sixth input terminal receiving the clock signal CK, and a sixth output terminal outputting an (n)th level starting signal ST(n). The bootstrap capacitor circuit 300 comprises a first capacitor C_{boost} and a seventh TFT T7. The first capacitor C_{boost} has two terminals which are connected with the gate signal point Q(n) and the scanning line G(n). The seventh TFT T7, has a seventh control terminal which receives a reset signal Reset, a seventh input terminal connected with the direct-low-voltage source VSS, and a seventh output terminal receiving the scanning line G(n).

The pull-up circuit 400 comprises an eighth TFT T8. The eighth TFT T8 has an eighth control terminal which receives an (n−3)th level starting signal ST(n−3), an eighth input terminal connected with the eighth control terminal, and an eighth output terminal connected with the gate signal point Q(n). The eighth TFT T8 receives the (n−3)th level starting signal ST(n−3); a function of the (n−3)th level starting signal ST(n−3) is to pull up the potential of the gate signal point Q(n), to make the (n)th level GOA unit turned on to output the scanning line G(n) accordingly.

The pull-down circuit 200 comprises a ninth TFT T9 and a tenth TFT T10. The ninth TFT T9 has a ninth control terminal which receives an (n+3)th level starting signal ST(n+3), a ninth input terminal connected with the direct-low-voltage source VSS, and a ninth output terminal connected with the gate signal point Q(n). The tenth TFT T10 has a tenth control terminal which is connected with the ninth control terminal, a tenth input terminal connected with the direct-low-voltage source VSS, and a tenth output terminal connected with the scanning line G(n).

The control terminals (gate electrodes) of the ninth TFT T9 and the tenth TFT T10 receive the (n+3)th level starting signal ST(n+3). The output terminals (drain electrodes) of the ninth TFT T9 and the tenth TFT T10 are respectively connected with the scanning line G(n) and the gate signal point Q(n). The input terminals (source electrodes) of the ninth TFT T9 and the tenth TFT T10 are connected with the direct-low-voltage source VSS. A function of the pull-down circuit 200 is to pull down the potential of the scanning line G(n) and the gate signal point Q(n) to be the same as the direct-low-voltage source VSS, to ensure the normal working of the panel, after the gate pulse of the (n)th level GOA unit 35 has been outputted.

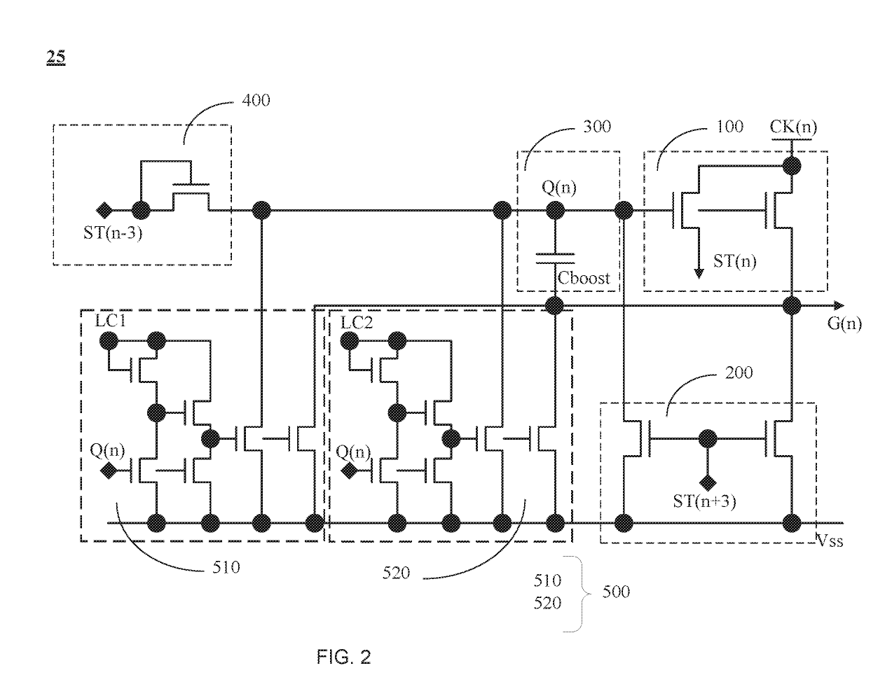

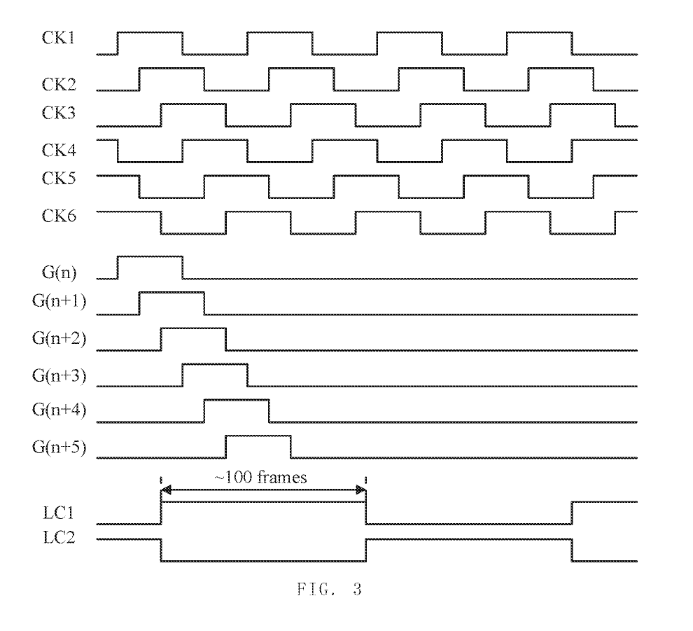

While the (n)th level GOA unit 35 is working, the potential of the gate signal point Q(n) is only affected by two TFTs, one is the eighth TFT T8 for receiving the (n−3)th level starting signal ST(n−3), wherein the eighth TFT T8 is used to pull up the potential of the gate signal point Q(n), to make the (n)th level GOA unit 35 output gate pulse; the other one is the tenth TFT T10 for receiving the (n+3)th level starting signal ST(n+3), wherein the tenth TFT T10 is used to pull down the potential of the gate signal point Q(n), after the gate pulse of the (n)th level GOA unit 35 has been outputted. In the rest of the time, the gate signal point Q(n) is not affected by other signals; by functioning of the pull-down sustain circuit 500, the gate signal point Q(n) is maintained at the low potential, hence, the reliability of the GOA circuit 30 is not affected by any influence. Compared with the GOA circuit of FIG. 2, there are seventeen TFTs in one level GOA unit 25 in FIG. 2; however, there are only ten TFTs in one level GOA unit 35 in FIG. 4, wherein the seventh TFT T7 included in the ten TFTs is used for Reset. In using the design of the present invention to the GOA circuit, each level GOA unit can reduce seven TFTs, whereby an enormous amount of wiring space is saved, which is advantageous to the narrow bezel design.

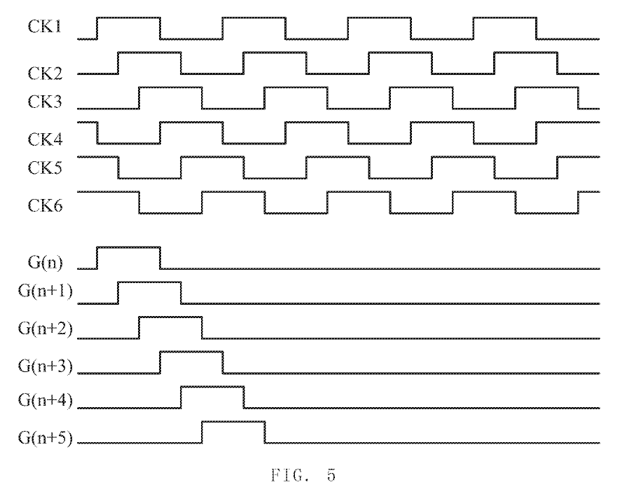

FIG. 5 is an oscillogram diagram of the GOA circuit of FIG. 4. Compared with the oscillogram diagram of the prior art, the oscillogram diagram of the present invention is the same as the oscillogram diagram of the prior art; hence, it is ensured that the GOA circuit of the present invention has the same technical effect as the GOA circuit of the prior art, with effectively reducing the number of the usage of the TFTs.

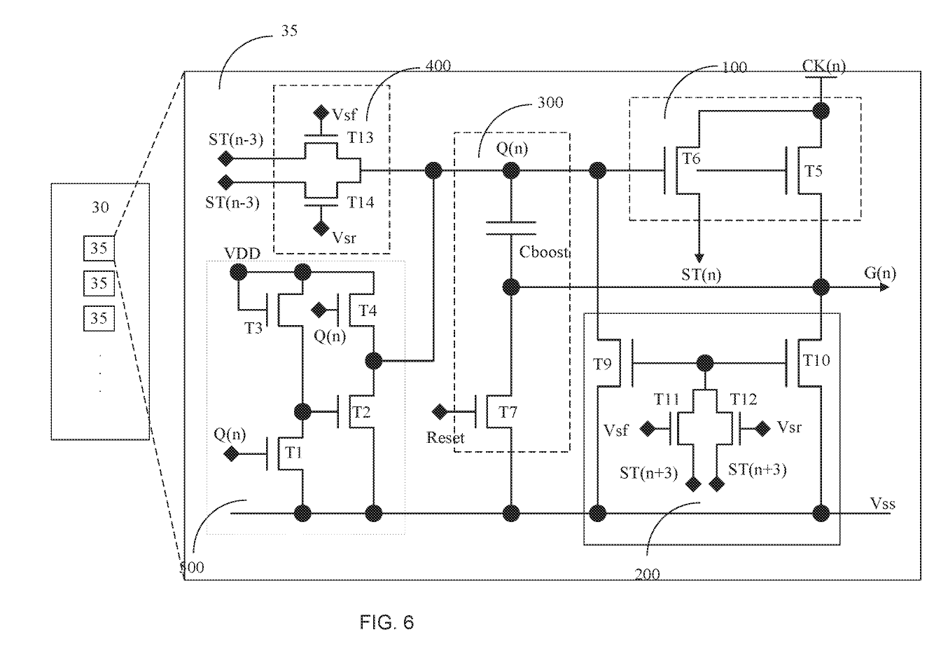

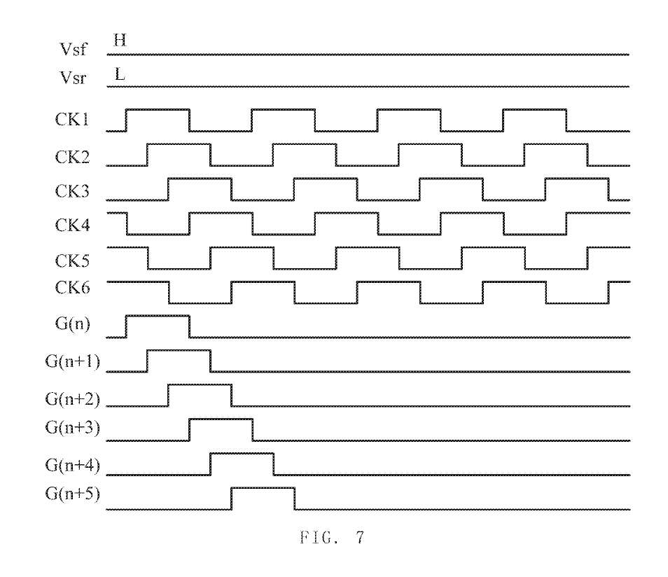

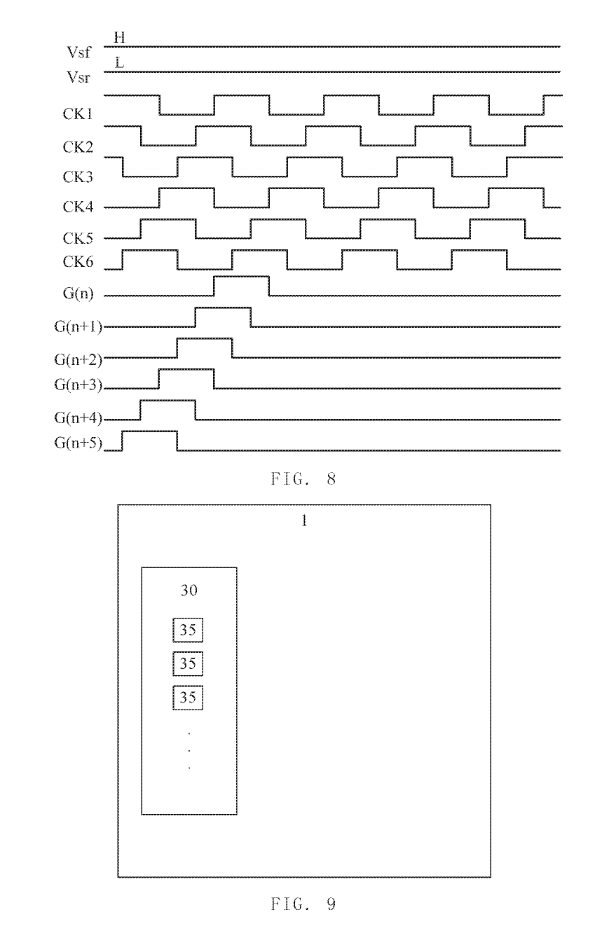

Please refer to FIGS. 6-8. FIG. 6 is a structural illustrative drawing of a GOA circuit 40 of a second preferred embodiment of the present invention. FIG. 7 is a forward-scanning oscillogram diagram of the GOA circuit of FIG. 6. FIG. 8 is a rearward-scanning oscillogram diagram of the GOA circuit of FIG. 6.

The difference between the second preferred embodiment and the first preferred embodiment is: the pull-down circuit 200 and the pull-up circuit 400 of the second preferred embodiment are different from those of the first preferred embodiment. Two signals are added and the amount of the TFTs of each level GOA unit are increased from ten to thirteen, wherein the purpose of such increase is to expand a function of rearward-scanning; the differences are described below:

The pull-down circuit 200 comprises a ninth TFT T9, a tenth TFT T10, an eleventh TFT T11, and a twelfth TFT T12. The ninth TFT T9 has a ninth input terminal connected with the direct-low-voltage source VSS, and a ninth output terminal connected with the gate signal point Q(n). The tenth TFT T10 has a tenth control terminal which is connected with a ninth control terminal, a tenth input terminal connected with the direct-low-voltage source VSS, and a tenth output terminal connected with the scanning line G(n). The eleventh TFT T11 has an eleventh control terminal which receives a forward scanning signal Vsf, an eleventh input terminal receiving an (n+3)th level starting signal ST(n+3), and an eleventh output terminal connected with the tenth control terminal. The twelfth TFT T12 has a twelfth control terminal which receives a rearward scanning signal Vsr, a twelfth input terminal receiving an (n−3)th level starting signal ST(n−3), and a twelfth output terminal connected with the eleventh output terminal.

The pull-up circuit 400 comprises a thirteenth TFT T13 and a fourteenth TFT T14.

The thirteenth TFT T13 has a thirteenth control terminal which receives the forward scanning signal Vsf, a thirteenth input terminal receiving an (n−3)th level starting signal ST(n−3), and a thirteen output terminal connected with the gate signal point Q(n). The fourteenth TFT T14 has a fourteenth control terminal which receives a rearward scanning signal Vsr, a fourteenth input terminal receiving an (n+3)th level starting signal ST(n+3), and a fourteenth output terminal connected with the thirteenth output terminal.

Different TV manufacturers might have entirely different device designs, even applying to the same LCD panel; hence, there are many requests for different scanning directions. Some manufacturers need forward scanning (Normal Scan), in which the gate lines are turned on with the sequence of G1→G2→G3→ . . . Gn→Gn+1; however, some manufacturers need rearward scanning (Reverse Scan), in which the gate lines are turned on with the sequence of Gn+1→Gn→ . . . G3→G2→G1. The GOA circuit of FIG. 6 is used to satisfy the two requests at the same time. The scanning direction of the GOA circuit is controlled by adding the forward scanning signal Vsf and the rearward scanning signal Vsr. When the forward scanning signal Vsf is at high potential and the rearward scanning signal Vsr is at low potential, the circuit of FIG. 6 is forward scanning mode. The gate signal point Q(n) is pulled up by the (n−3)th level starting signal ST(n−3), the GOA circuit 45 is on to output the gate pulse, and the GOA circuit 45 is off by the (n+3)th level starting signal ST(n+3) after the gate pulse has been outputted. The corresponding oscillogram diagram of this working mode is shown in FIG. 7. On the contrary, when the forward scanning signal Vsf is at low potential and the rearward scanning signal Vsr is at high potential, the circuit of FIG. 6 is rearward scanning mode. The gate signal point Q(n) is pulled up by the (n+3)th level starting signal ST(n+3), the GOA circuit 45 is on to output the gate pulse, and the GOA circuit 45 is off by the (n−3)th level starting signal ST(n−3) after the gate pulse has been outputted. The corresponding oscillogram diagram of this working mode is shown in FIG. 8.

Please refer to FIG. 9, which is a drawing of an LCD device 1 of the present invention. The LCD device 1 comprises the GOA circuit of the first preferred embodiment. Alternatively, the LCD device 1 can comprise the GOA circuit of the second preferred embodiment.

Although the present invention has been disclosed as preferred embodiments, the foregoing preferred embodiments are not intended to limit the present invention. Those of ordinary skill in the art, without departing from the spirit and scope of the present invention, can make various kinds of modifications and variations to the present invention. Therefore, the scope of the claims of the present invention must be defined.

What is claimed is:

1. A GOA (Gate driver On Array) circuit for an LCD (Liquid Crystal Display) device, the LCD device comprising a plurality of scanning lines, the GOA circuit comprising:
a plurality of GOA units, being cascaded to each other as a plurality level of GOA units,
wherein an (n)th level GOA unit charges a scanning line correspondingly, the (n)th level GOA unit comprising:
a pull-down sustain circuit, being used to connect with a gate signal point;
a pull-up circuit, being used to connect with the pull-down sustain circuit through the gate signal point;
a bootstrap capacitor circuit, being used to connect with the pull-up circuit through the gate signal point;
a pull-down circuit, being used to connect with the bootstrap capacitor circuit through the gate signal point; and
a clock circuit, being used to connect with the pull-down circuit through the gate signal point and the scanning line, and being used to receive a clock signal;
wherein the pull-down sustain circuit, the bootstrap capacitor circuit, and the pull-down circuit all connect to a direct-low-voltage source;
the pull-down sustain circuit comprising:
a first TFT (thin film transistor) having a first control terminal which is connected with an input signal point, and having an second output terminal connected with the direct-low-voltage source;
a second TFT having a second control terminal which is connected with a first input terminal of the first TFT, a second input terminal connected with the direct-low-voltage source, and a second output terminal connected with an output signal point;
a third TFT, which comprises a third control terminal, a third output terminal, and a third input terminal, the third control terminal and the third output terminal connected with a direct-high-voltage source, and the third input terminal connected with the first input terminal;
a fourth TFT having a fourth control terminal which is connected with the gate signal point, a fourth output connected with the third control terminal, and a fourth input terminal connected with the output signal point, the output signal point connected with the gate signal point;
wherein the bootstrap capacitor circuit comprises a seventh TFT, which has a seventh control terminal which receives a reset signal, a seventh input terminal connected with the direct-low-voltage source, and a seventh output terminal receiving the scanning line, the clock circuit comprising a fifth TFT, which has a fifth control terminal connected with the gate signal point, a fifth input terminal receiving the clock signal, and a fifth output terminal connected with the scanning line.

2. The GOA circuit for the LCD device according to claim 1, wherein the clock circuit comprises:
a sixth TFT having a sixth control terminal which is connected with the gate signal point,
a sixth input terminal receiving the clock signal, and a sixth output terminal outputting an (n)th level starting signal.

3. The GOA circuit for the LCD device according to claim 1, wherein the bootstrap capacitor circuit comprises:
a first capacitor having two terminals which are connected with the gate signal point and the scanning line.

4. The GOA circuit for the LCD device according to claim 1, wherein the pull-up circuit comprises:
an eighth TFT having an eighth control terminal which receives an (n−3)th level starting signal, an eighth input terminal connected with the eighth control terminal, and an eighth output terminal connected with the gate signal point.

5. The GOA circuit for the LCD device according to claim 1, wherein the pull-down circuit comprises:
a ninth TFT having a ninth control terminal which receives an (n+3)th level starting signal, a ninth input terminal connected with the direct-low-voltage source, and a ninth output terminal connected with the gate signal point; and
a tenth TFT having a tenth control terminal which is connected with the ninth control terminal, a tenth input terminal connected with the direct-low-voltage source, and a tenth output terminal connected with the scanning line.

6. The GOA circuit for the LCD device according to claim 1, wherein the pull-down circuit comprises:
a ninth TFT having a ninth input terminal connected with the direct-low-voltage source, and a ninth output terminal connected with the gate signal point;
a tenth TFT having a tenth control terminal which is connected with a ninth control terminal, a tenth input terminal connected with the direct-low-voltage source, and a tenth output terminal connected with the scanning line;
an eleventh TFT having an eleventh control terminal which receives a forward scanning signal, an eleventh input terminal receiving an (n+3)th level starting signal, and an eleventh output terminal connected with the tenth control terminal; and
a twelfth TFT having a twelfth control terminal which receives a rearward scanning signal, a twelfth input terminal receiving an (n−3)th level starting signal, and a twelfth output terminal connected with the eleventh output terminal.

7. The GOA circuit for the LCD device according to claim 1, wherein the pull-up circuit comprises:
a thirteenth TFT having a thirteenth control terminal which receives a forward scanning signal, a thirteenth input terminal receiving an (n−3)th level starting signal, and a thirteenth output terminal connected with the gate signal point; and
a fourteenth TFT having a fourteenth control terminal which receives a rearward scanning signal, a fourteenth input terminal receiving an (n+3)th level starting signal, and a fourteenth output terminal connected with the thirteenth output terminal.

8. The GOA circuit for the LCD device according to claim 1, wherein the output signal point connects with the input signal point.

9. A GOA (Gate driver On Array) circuit for an LCD (Liquid Crystal Display) device, the LCD device comprising a plurality of scanning lines, the GOA circuit comprising:
a plurality of GOA units, being cascaded to each other as a plurality level of GOA units, wherein an (n)th level GOA unit charges a scanning line correspondingly, the (n)th level GOA unit comprising:
a pull-down sustain circuit, being used to connect with a gate signal point;
a pull-up circuit, being used to connect with the pull-down sustain circuit through the gate signal point;
a bootstrap capacitor circuit, being used to connect with the pull-up circuit through the gate signal point;
a pull-down circuit, being used to connect with the bootstrap capacitor circuit through the gate signal point; and
a clock circuit, being used to connect with the pull-down circuit through the gate signal point and the scanning line, and being used to receive a clock signal;
wherein the pull-down sustain circuit, the bootstrap capacitor circuit, and the pull-down circuit all connect to a direct-low-voltage source;
the pull-down sustain circuit comprising:
a first TFT (thin film transistor) having a first control terminal which is connected with an input signal point, and having an second output terminal connected with the direct-low-voltage source;
a second TFT having a second control terminal which is connected with a first input terminal of the first TFT, a second input terminal connected with the direct-low-voltage source, and a second output terminal connected with an output signal point;
a third TFT, which comprises a third control terminal, a third output terminal, and a third input terminal, the third control terminal and the third output terminal connected with a direct-high-voltage source, and the third input terminal connected with the first input terminal;
a fourth TFT having a fourth control terminal which is connected with the gate signal point, a fourth output connected with the third control terminal, and a fourth input terminal connected with the output signal point, the output signal point connected with the gate signal point.

10. The GOA circuit for the LCD device according to claim 9, wherein the clock circuit comprises:
a fifth TFT, which has a fifth control terminal connected with the gate signal point, a fifth input terminal receiving the clock signal, and a fifth output terminal connected with the scanning line; and
a sixth TFT having a sixth control terminal which is connected with the gate signal point, a sixth input terminal receiving the clock signal, and a sixth output terminal outputting an (n)th level starting signal.

11. The GOA circuit for the LCD device according to claim 9, wherein the bootstrap capacitor circuit comprises:
a first capacitor having two terminals which are connected with the gate signal point and the scanning line; and
a seventh TFT, which has a seventh control terminal which receives a reset signal, a seventh input terminal connected with the direct-low-voltage source, and a seventh output terminal receiving the scanning line.

12. The GOA circuit for the LCD device according to claim 9, wherein the pull-up circuit comprises:
an eighth TFT having an eighth control terminal which receives an (n−3)th level starting signal, an eighth input terminal connected with the eighth control terminal, and an eighth output terminal connected with the gate signal point.

13. The GOA circuit for the LCD device according to claim 9, wherein the pull-down circuit comprises:
a ninth TFT having a ninth control terminal which receives an (n+3)th level starting signal, a ninth input terminal connected with the direct-low-voltage source, and a ninth output terminal connected with the gate signal point; and
a tenth TFT having a tenth control terminal which is connected with the ninth control terminal, a tenth input terminal connected with the direct-low-voltage source, and a tenth output terminal connected with the scanning line.

14. The GOA circuit for the LCD device according to claim 9, wherein the pull-down circuit comprises:
a ninth TFT having a ninth input terminal connected with the direct-low-voltage source, and a ninth output terminal connected with the gate signal point;
a tenth TFT having a tenth control terminal which is connected with a ninth control terminal, a tenth input terminal connected with the direct-low-voltage source, and a tenth output terminal connected with the scanning line;
an eleventh TFT having an eleventh control terminal which receives a forward scanning signal, an eleventh input terminal receiving an (n+3)th level starting signal, and an eleventh output terminal connected with the tenth control terminal; and
a twelfth TFT having a twelfth control terminal which receives a rearward scanning signal, a twelfth input terminal receiving an (n−3)th level starting signal, and a twelfth output terminal connected with the eleventh output terminal.

15. The GOA circuit for the LCD device according to claim 9, wherein the pull-up circuit comprises:
a thirteenth TFT having a thirteenth control terminal which receives a forward scanning signal, a thirteenth input terminal receiving an (n−3)th level starting signal, and a thirteenth output terminal connected with the gate signal point; and
a fourteenth TFT having a fourteenth control terminal which receives a rearward scanning signal, a fourteenth input terminal receives an (n+3)th level starting signal, and a fourteenth output terminal connected with the thirteenth output terminal.

16. The GOA circuit for the LCD device according to claim 9, wherein the output signal point connects with the input signal point.

17. An LCD device, which comprises the GOA circuit of claim 9.
